(19) United States
(12) Patent Application Publication
(10) Pub. No.: US 2024/0088571 A1
(43) Pub. Date: Mar. 14, 2024

(54) ARRAY ANTENNA BANDWIDTH ENHANCEMENT METHOD BASED ON PHASE REGULATION AND CONTROL, APPARATUS AND ARRAY ANTENNA

(71) Applicant: BEIJING JIAOTONG UNIVERSITY, Beijing (CN)

(72) Inventors: Yujian Li, Beijing (CN); Xiaojuan Wang, Beijing (CN); Fanqi Sun, Beijing (CN); Junhong Wang, Beijing (CN)

(21) Appl. No.: 18/337,579

(22) Filed: Jun. 20, 2023

(30) Foreign Application Priority Data
Sep. 13, 2022 (CN) 202211110629.2

(51) Int. Cl. H01Q 21/00

(52) U.S. Cl. CPC H01Q 21/0037

(57) ABSTRACT

Embodiments of the present disclosure provide an array antenna bandwidth enhancement method based on phase regulation and control, an apparatus and an array antenna, a reflection coefficient of the array is calculated utilizing a one-time-reflection model calculation formula determined based on a small reflection theory, thus saving a full-wave simulation time of a large-scale array, and greatly improving a design efficiency. Enhancement of a bandwidth of the array using the array bandwidth enhancement method based on phase regulation and control may save a time for stepwise increased and matching adjustment of the large-scale array, and reduce design complexity. The provided method is simple and efficient, and is beneficial to realization of a wideband design of the large-scale array antenna.

### CROSS-REFERENCE TO RELATED APPLICATION

The present disclosure claims the priority to the Chinese patent application with the filing No. 202211110629.2 filed with the Chinese Patent Office on Sep. 13, 2022, and entitled “ARRAY ANTENNA BANDWIDTH ENHANCEMENT METHOD BASED ON PHASE REGULATION AND CONTROL, APPARATUS AND ARRAY ANTENNA”, the contents of which are incorporated herein by reference in its entirety.

### TECHNICAL FIELD

The present disclosure relates to the field of antenna technologies, and particularly to an array antenna bandwidth enhancement method based on phase regulation and control, an apparatus and an array antenna.

### BACKGROUND ART

A large-scale millimeter wave antenna array with a high gain and a wide operating band is a key technology for realizing important millimeter wave communication applications, such as millimeter wave wireless backhaul and millimeter wave large-scale multiple-input multiple-output (MIMO) systems, or the like. Multiple millimeter wave frequency bands are included in existing 5G communication, adoption of multiple antennas with different physical apertures to meet multi-band communication requirements is easy to implement but significantly increases a physical aperture of the whole antenna, which is not beneficial to realize the miniaturization and integration of a system, and therefore, in order to improve a performance of a millimeter wave system, a broadband antenna array capable of covering multiple millimeter wave frequency bands in a single aperture is required.

Usually, an array antenna is consisted of a feed network and radiation elements, and therefore, bandwidth characteristics of the feed network and the radiation element play a decisive role in a bandwidth characteristics of the entire array. On the one hand, due to impedance matching characteristics of the radiation element and power dividers and an influence of an overall topology of the array, the existing millimeter wave arrays have a great challenge to achieve broadband. On the other hand, even though both the power dividers and the radiation element realize a wide bandwidth, after array formation, a high reflection may be generated in an operating band, thereby cutting off an operating bandwidth, and therefore, in a common array antenna, a mode of stepwise increased and matching adjustment is usually adopted to achieve a certain bandwidth. However, a current research method mainly depends on electromagnetic simulation software for full-wave simulation calculation, required calculation resources and a required calculation time cost are significantly increased with an increase of an array scale, and therefore, a method capable of effectively inhibiting the high reflection is required to be provided, so as to enhance the bandwidth of the array antenna, reduce a time of matching adjustment when the array antenna is designed, and reduce complexity of a design process.

### SUMMARY

In view of this, embodiments of the present disclosure provide an array antenna bandwidth enhancement method based on phase regulation and control, an apparatus and an array antenna, which can effectively inhibit a high reflection, enhance a bandwidth of the array antenna, reduce a time of matching adjustment when the array antenna is designed, and reduce complexity of a design process.

In a first aspect, an embodiment of the present disclosure provides an array antenna bandwidth enhancement method based on phase regulation and control, including: determining a size of an array antenna based on engineering requirements, and forming a broadband subarray and a feed network according to the size of the array antenna, wherein the feed network is formed by connecting a plurality of stages of power dividers in parallel; determining a one-time-reflection model formula based on a small reflection theory, wherein the one-time-reflection model formula is used for representing a corresponding relationship among a reflection coefficient and the size of the array antenna, a reflection coefficient of the power divider and path length of the feed network; adjusting added values of the lengths of the paths of the feed network in conjunction with an optimization algorithm, further adjusting a phase compensation value, calculating the reflection coefficient corresponding to the array antenna using the one-time-reflection model formula, and finally obtaining a maximum bandwidth with the reflection coefficient lower than a preset amplitude value and the corresponding added value of the length of the path; and employing the bending structures to change the lengths of the plurality of paths in the feed network according to the added values of the lengths of the paths, and re-arraying the bending structure to enhance the bandwidth of the array antenna. (In particular, a method for realizing phase regulation and control includes changing a dimension of wide side of feed waveguide in addition to adjusting the length of the path of the feed network.)

Further, in the method, the one-time-reflection model formula is represented as follows:

$$Γ = {Γ}_{1} + {\sum }_{i = 2}^{M + N} ( {Γ}_{i} \cdot {e}^{- 2 j {θ}_{i - 1}} \cdot {\prod }_{2}^{i} {Tr}_{i - 1} ) + {Γ}_{L} \cdot {e}^{- 2 j {θ}_{M + N}} {\prod }_{1}^{M + N} {Tr}_{i} ;$$

wherein Γ is the reflection coefficient, Γᵢ is the reflection coefficient of the power divider Tᵢ, Trᵢ=1+Γᵢ, Trᵢ is a transmission coefficient of the power divider Tᵢ (i=1, 2, 3, . . . , M+N), Γ_{L} is a reflection coefficient of the subarray (load) in the array antenna, θᵢ₋₁=βLᵢ₋₁ (i=2, 3, . . . , M+N), θ is a phase delay, β is a phase constant, Lᵢ₋₁=lᵢ₋₁+Δlᵢ₋₁+Lᵢ₋₂ (i=2, 3, . . . , M+N), Lᵢ₋₁ is a path length from a input port of the feed network to power divider Tᵢ and L_{M+N} is the path length from the input port of the array to the load, lᵢ₋₁ is a path length between power dividers Tᵢ₋₁ and Tᵢ, l_{M+N} is the path length between power divider T_{M+N} and the loads. Δlᵢ₋₁, is an added value of the path length between the power divider Tᵢ₋₁ and Tᵢ, Δl_{M+N} is an added path length between power divider T_{M+N} and the loads, and M+N is a number of the power dividers in the feed network. L₀ is set to 0.

Further, in the method, the step of adjusting added values of the lengths of the plural paths in the feed network in conjunction with an optimization algorithm, further adjusting a phase compensation value, determining the reflection coefficient corresponding to the array antenna using the one-time-reflection model formula, and obtaining a maximum bandwidth with the reflection coefficient lower than a preset value and the corresponding added value of the path length includes: adjusting the added values of the lengths of the plural paths in the feed network, and further adjusting the phase compensation value, so as to adjust phase delays generated by a plurality of small reflections in the feed network at different operating frequencies, the added values of the lengths of the plural paths in the feed network corresponding to optimization variables in the optimization algorithm; substituting a phase of the small reflection into the one-time-reflection model formula to obtain an amplitude value of the corresponding reflection coefficient; evaluating fitness of the added value of the path length based on the amplitude value, a fitness function being the maximum bandwidth with the reflection coefficient of the array antenna lower than the preset amplitude value, and performing plural iterations to obtain an optimal solution; and obtaining the maximum bandwidth with the reflection coefficient lower than the preset amplitude value and the corresponding added value of the length of the path.

Further, the method further includes: evaluating the fitness of the added value of the length of the path based on the following formula: BW′=max((fₘₐₓ−fₘᵢₙ)/f₀), wherein BW′ is the fitness, fₘₐₓ is a frequency corresponding to an upper limit of the amplitude value, fₘᵢₙ is a frequency corresponding to a lower limit of the amplitude value, and f₀=(fₘₐₓ fₘᵢₙ)/2 which is a center frequency.

Further, in the method, the optimization algorithm includes one of the following algorithms: a particle swarm optimization algorithm, a genetic algorithm, a simulated annealing algorithm and a neural network algorithm.

In a second aspect, an embodiment of the present disclosure further provides an array antenna bandwidth enhancement design apparatus, including: a first determining module, configured to determine a size of an array antenna based on engineering requirements, and form a broadband subarray and a feed network according to the size of the array antenna, wherein the feed network is formed by connecting a plurality of stages of power dividers in parallel; a second determining module, configured to determine a one-time-reflection model formula based on a small reflection theory, wherein the one-time-reflection model formula is used for representing a corresponding relationship among a reflection coefficient and the size of the array antenna, a reflection coefficient of the power divider and a path length of the feed network; a third determining module, configured to adjust added values of the lengths of the paths of the feed network in conjunction with an optimization algorithm, further adjust a phase compensation value, determine the reflection coefficient corresponding to the array antenna using the one-time-reflection model formula, and obtain a maximum bandwidth required with the reflection coefficient lower than a preset amplitude value and the corresponding added value of the path length; and an array forming module, configured to employ the bending structures to change the lengths of the plurality of paths in the feed network according to the added values of the lengths of the paths, and re-form the bending structures to enhance the bandwidth of the array antenna.

In a third aspect, an embodiment of the present disclosure further provides an air-filled waveguide array antenna obtained using the foregoing method and including: a feed network and a subarray, wherein the feed network is formed by connecting a plurality of stages of power dividers in parallel; the subarray is connected at an output port of the feed network as a terminal load.

Further, the array antenna further includes a plurality of subarrays, and each subarray is composed of a plurality of power dividers and a plurality of radiation elements.

The embodiments of the present disclosure have the following beneficial effects.

The embodiments of the present disclosure provide the array antenna bandwidth enhancement method based on phase regulation and control, the apparatus and the array antenna, the reflection coefficient of the array is calculated utilizing the one-time-reflection model calculation formula determined based on the small reflection theory, thus saving a full-wave simulation time of a large-scale array, and greatly improving a design efficiency. Enhancement of the bandwidth of the array using the array bandwidth enhancement method based on phase regulation and control can save a time for stepwise changed and matching adjustment of the large-scale array, and reduce design complexity. The provided method is simple and efficient and is beneficial to realization of a broadband design of the large-scale array antenna.

Other features and advantages of the embodiments of the present disclosure will be stated in the following description or part of the features and advantages can be inferred or undoubtedly determined from the description or be learnt by implementing the aforementioned technique of the present disclosure.

In order to make the above mentioned objects, features, and advantages of the embodiments of the present disclosure more apparent, preferred embodiments are described in detail hereinafter by referring to the accompanying drawings.

### BRIEF DESCRIPTION OF DRAWINGS

To describe the technical solutions in the specific embodiments of the present disclosure or the prior art more clearly, the following briefly describes the accompanying drawings required for describing the specific embodiments or the prior art. Apparently, the accompanying drawings in the following description show some embodiments of the present disclosure, and a person of ordinary skill in the art may still derive other drawings from these accompanying drawings without creative efforts.

FIG. 1 is a flow chart of an array antenna bandwidth enhancement method based on phase regulation and control according to an embodiment of the present disclosure;

FIG. 2 is a schematic diagram of a topology of a large-scale array antenna according to an embodiment of the present disclosure;

FIG. 3 is a graph of a reflection coefficient before and after optimization of an array with an 8×8 feed network in an embodiment of the present disclosure;

FIG. 4 is a schematic structural diagram of an array antenna bandwidth enhancement design apparatus according to an embodiment of the present disclosure;

FIG. 5 is a structural diagram of a 16×16 large-scale wideband planar array antenna according to an embodiment of the present disclosure;

FIG. 6 is a schematic diagram of a three-dimensional structure of a 4×4 subarray in an embodiment of the present disclosure;

FIG. 7 is a side view of a 4×4 subarray in an embodiment of the present disclosure;

FIG. 8 is a schematic structural diagram of a power divider in an embodiment of the present disclosure;

FIG. 9 is a schematic structural diagram of a feed network in an embodiment of the present disclosure;

FIG. 10 is a schematic diagram of a bending structure for increasing a path length of a feed network in an embodiment of the present disclosure;

FIG. 11 is a schematic structural diagram of a power divider with an increased path length in an embodiment of the present disclosure;

FIG. 12 is a schematic diagram of a three-dimensional structure of a feed network with an increased path length in an embodiment of the present disclosure;

FIG. 13 is a top view of a feed network with an increased path length in an embodiment of the present disclosure;

FIG. 14 is a schematic diagram of a three-layer structure of an array with an increased path length in an embodiment of the present disclosure;

FIG. 15 is a graph of a reflection coefficient of a 16×16 large-scale air-filled waveguide array antenna with an enhanced bandwidth according to an embodiment of the present disclosure; and

FIG. 16 is a schematic structural diagram of an electronic device according to an embodiment of the present disclosure.

### REFERENCE NUMERALS

1—subarray; 2—feed network; 3—power divider; 4—sub—feed network; 5—H—plane power divider; 6—radiation element; 7—triangular iris; 8—rectangular iris; 9—bending structure; 10—triangular iris and rectangular iris structure; 11—bending joint; 12—power divider with increased path length; 13—feed network with increased path length; 14—standard waveguide inlet; 15—metal body; 16—flange; 401—first determining module; 402—second determining module; 403—third determining module; 404—arraying module; 50—processor; 51—memory; 52—bus; 53—communication interface.

### DETAILED DESCRIPTION

Various technical solutions of the present disclosure are described with reference to the accompanying drawings, although the described embodiments are not all but a part of the embodiments of the present disclosure. Other embodiments obtained by a person of ordinary skill in the art based on the embodiments of the present disclosure without creative efforts fall within the protection scope of the present disclosure.

Currently, an existing array antenna mainly relies on electromagnetic simulation calculation software to perform full-wave simulation calculation, and in a common array antenna, a stepwise increased and matching adjustment mode is usually adopted to achieve a certain bandwidth, a demand on computing resources is increased remarkably with an increase of an array scale, and realization of broadband characteristics of large-scale arrays using a method of simulating and optimizing structural parameters obviously consumes a large number of computing resources and increases a computing time cost. Embodiments of the present disclosure provide an array antenna bandwidth enhancement method based on phase regulation and control, an apparatus and an array antenna, a reflection coefficient of the array is calculated utilizing a one-time-reflection model calculation formula determined based on a small reflection theory, thus saving a full-wave simulation time of a large-scale array, and greatly improving a design efficiency. Enhancement of a bandwidth of the array using the array bandwidth enhancement method based on phase regulation and control may save a time for stepwise increased and matching adjustment of the large-scale array, and reduce design complexity. The provided method is simple and efficient, and is beneficial to realization of a broadband design of the large-scale array antenna.

To facilitate understanding of the present embodiment, an array antenna bandwidth enhancement method based on phase regulation and control according to an embodiment of the present disclosure is first described in detail.

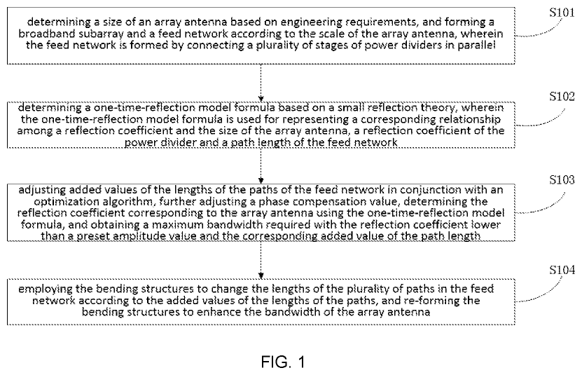

An embodiment of the present disclosure provides an array antenna bandwidth enhancement method based on phase regulation and control. FIG. 1 is a flow chart of an array antenna bandwidth enhancement method based on phase regulation and control according to the embodiment of the present disclosure, and as shown in FIG. 1, the method includes the following steps.

Step S101: determining a size of an array antenna based on engineering requirements, and forming a broadband subarray and a feed network according to the size of the array antenna, wherein the feed network is formed by connecting a plurality of stages of power dividers in parallel.

In practical applications, an operating band and a center frequency of the array antenna may be designed according to the actual engineering requirements, and a form, a dimension and an element spacing of radiation elements and the size of the array antenna may be selected.

Step S102: determining a one-time-reflection model formula based on a small reflection theory, wherein the one-time-reflection model formula is used for representing a corresponding relationship among a reflection coefficient and the size of the array antenna, a reflection coefficient of the power divider and a path length of the feed network.

Specifically, the one-time-reflection model calculation formula may be determined using the small reflection theory, and the reflection coefficient of the array may be calculated.

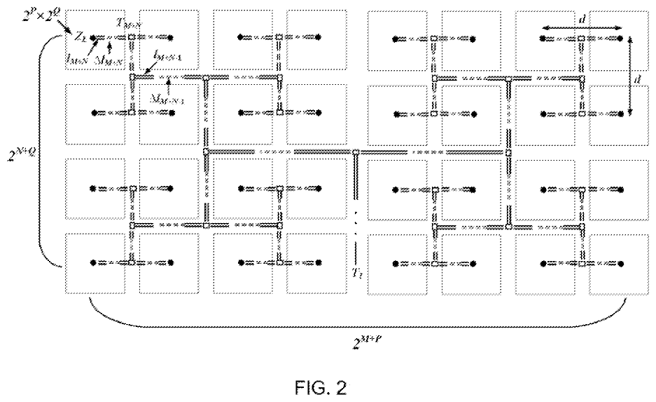

More specifically, referring to a topology of a large-scale array shown in FIG. 2, the radiation element has a size of 2^{M+P}×2^{N+Q}, the feed network has a size of 2^{M}×2^{N}, a number of the power dividers constituting the feed network is M+N, the subarray has a size of 2^{P}×2^{Q}, the element spacing of the radiation element is d, and the element spacing in two dimensions in the designed array may be set to different values. It may be seen from the full-corporate feed network of the array that there may exist small reflections in the feed network due to discontinuity of the power dividers, and the total reflection coefficient of an input port of the feed network may be calculated using the following one-time-reflection model formula determined based on the small reflection theory.

Specifically, the above one-time-reflection model formula may be represented by the following formula:

$$Γ = {Γ}_{1} + {\sum }_{i = 2}^{M + N} ( {Γ}_{i} \cdot {e}^{- 2 j {θ}_{i - 1}} \cdot {\prod }_{2}^{i} {Tr}_{i - 1} ) + {Γ}_{L} \cdot {e}^{- 2 j {θ}_{M + N}} {\prod }_{1}^{M + N} {Tr}_{i}$$

wherein Γ is the reflection coefficient, Γᵢ is the reflection coefficient of the power divider Tᵢ, Trᵢ=1+Γᵢ, Trᵢ is a transmission coefficient of the power divider Tᵢ (i=1, 2, 3, . . . , M+N), Γ_{L} is a reflection coefficient of the subarray (load) in the array antenna, θᵢ₋₁=βLᵢ₋₁ (i=2, 3, . . . , M+N), θ is a phase delay, θ is a phase constant, Lᵢ₋₁=lᵢ₋₁+Δlᵢ₋₁+Lᵢ₋₂ (i=2, 3, . . . , M+N), Lᵢ₋₁ is a path length from a input port of the feed network to power divider Tᵢ and L_{M+N} is the path length from the input port of the array to the load, lᵢ₋₁ is a path length between power dividers Tᵢ₋₁ and Tᵢ, l_{M+N} is the path length between power divider T_{M+N} and the loads. Δlᵢ₋₁, is an added value of the path length between the power divider Tᵢ₋₁ and Tᵢ, Δl_{M+N} is an added path length between power divider T_{M+N} and the loads, and M+N is a number of the power dividers in the feed network. L₀ is set to 0.

Step S103: adjusting added values of the lengths of the paths of the feed network in conjunction with an optimization algorithm, further adjusting a phase compensation value, determining the reflection coefficient corresponding to the array antenna using the one-time-reflection model formula, and obtaining a maximum bandwidth required with the reflection coefficient lower than a preset amplitude value and the corresponding added value of the path length.

In practical applications, the adopted optimization algorithm includes one of the following algorithms: a particle swarm optimization algorithm, a genetic algorithm, a simulated annealing algorithm, a neural network algorithm, or the like.

Specifically, the method of adjusting added values of the lengths of the plural paths of the feed network in conjunction with an optimization algorithm, further adjusting a phase compensation value, determining the reflection coefficient corresponding to the array antenna using the one-time-reflection model formula, and obtaining a maximum bandwidth required with the reflection coefficient lower than a preset amplitude value and the corresponding added value of the path length can be implemented by the following steps A1 to A4.

Step A1: adjusting the added values of the lengths of the plural paths in the feed network, and further adjusting the phase compensation value, so as to adjust phase delays generated by a plurality of small reflections in the feed network at different operating frequencies, the added values of the lengths of the plural paths in the feed network corresponding to optimization variables in the optimization algorithm.

Specifically, since a high reflection exists in an operating band of the array antenna, the path length of the feed network may be adjusted to regulate and control the phases of the plural small reflections, so as to further change the reflection coefficient, thereby suppressing the high reflection in the operating band of the array antenna, and enhance the bandwidth of array.

More specifically, the feed network is formed by connecting the plural stages of power dividers in parallel, and it may be seen from the phase calculation formula θᵢ₋₁, =βLᵢ₋₁, in the above-mentioned process that the phase of the small reflection can be adjusted by changing the path length of the feed network, and then, the phase of the small reflection is substituted into the one-time-reflection model calculation formula to obtain the corresponding reflection coefficient, and therefore, high reflection, i.e., an in-phase superposition effect, at a certain frequency may be weakened using the above-mentioned method.

Step A2: substituting a phase of the small reflection into the one-time-reflection model formula to obtain an amplitude value of the corresponding reflection coefficient.

In practical applications, based on the above steps, since the operating band of the array includes plural frequencies, when the path length is changed, both the phase of the small reflection at the frequency required to be adjusted and the phases of the small reflection at other frequencies are changed, and therefore, in order to achieve an optimal effect of adjusting the phase of the small reflection, that is, to guarantee within the maximum bandwidth to avoid that the in-phase superposition effect of the small reflection makes the reflection coefficient thereof higher than the required amplitude value to cut off the bandwidth, the bandwidth of the array is optimized using the particle swarm algorithm.

Here, the bandwidth of the array may be optimized using the particle swarm optimization algorithm, the genetic algorithm, the simulated annealing algorithm, the neural network algorithm, or the like, and an optimization variable is the added value of the path length of the feed network; in practical applications, the number of the adjustable paths of the feed network, i.e., the number of the optimization variables, may be determined according to a designed array structure, and the specific number is not limited herein.

Step A3: evaluating fitness of the added value of the path length based on the amplitude value, wherein a fitness function is the maximum bandwidth with the reflection coefficient of the array antenna lower than the preset amplitude value, and performing plural iterations to obtain an optimal solution.

Specifically, the fitness of the added value of the path length may be evaluated based on the following formula:

BW′=max((fₘₐₓ−fₘᵢₙ)/f₀)
wherein BW′ is the fitness, fₘₐₓ is a frequency corresponding to an upper limit of the amplitude value, f mm is a frequency corresponding to a lower limit of the amplitude value, and f₀=(fₘₐₓ+fₘᵢₙ)/2, which is the center frequency.

Step A4: finally obtaining the maximum bandwidth with the reflection coefficient lower than the preset reflection coefficient and the corresponding added value of the path length.

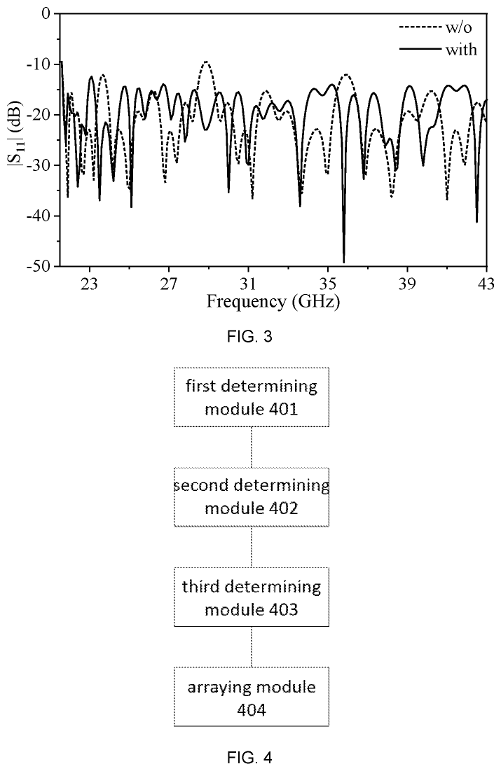

Step S104: employing the bending structures to change the lengths of the plurality of paths in the feed network according to the added values of the lengths of the paths, and re-arraying the bending structures to enhance the bandwidth of the array antenna. Specifically, taking an array antenna with an 8×8 feed network as an example. FIG. 3 shows a graph of a reflection coefficient before and after optimization of an array with an 8×8 feed network, it may be seen that a −10 dB impedance bandwidth of the array is effectively enhanced by the phase regulation and control method according to the present disclosure. The element spacing of the array antenna is 0.844λ₀, and both the magnitude and phase of the Γ_{L} and Γᵢ, are set to −25 dB and 180°.

Specifically, the set reflection coefficient may also be other values simulated by designed model simulation software, the reflection coefficient of the power divider and the reflection coefficient of the load may also be other values, and the specific values are not limited herein.

Corresponding to the foregoing method embodiment, an embodiment of the present disclosure provides an array antenna bandwidth enhancement design apparatus, FIG. 4 shows a schematic structural diagram of an array antenna bandwidth enhancement design apparatus, and as shown in FIG. 4, the array antenna bandwidth enhancement design apparatus includes:
a first determining module 401, configured to determine a size of an array antenna based on engineering requirements, and form a broadband subarray and a feed network according to the size of the array antenna, wherein the feed network is formed by connecting a plurality of stages of power dividers in parallel;
a second determining module 402, configured to determine a one-time-reflection model formula based on a small reflection theory, wherein the one-time-reflection model formula is used for representing a corresponding relationship among a reflection coefficient and the size of the array antenna, a reflection coefficient of the power divider and a path length of the feed network;
a third determining module 403, configured to adjust added values of the lengths of the paths of the feed network in conjunction with an optimization algorithm, further adjust a phase compensation value, determine the reflection coefficient corresponding to the array antenna using the one-time-reflection model formula, and obtain a maximum bandwidth with the reflection coefficient lower than a preset amplitude value and the corresponding added value of the path length;
an arraying module 404, configured to employ the bending structures to change the lengths of the plurality of paths in the feed network according to the added values of the lengths of the paths, and re-form the bending structures to enhance the bandwidth of the array antenna.

Corresponding to the foregoing method embodiment, an embodiment of the present disclosure provides an array antenna obtained using the foregoing method and including: a feed network and a subarray, wherein the feed network is formed by connecting a plurality of stages of power dividers in parallel; the subarray is connected at an output port of the feed network as a terminal load.

Specifically, the array antenna further includes a plurality of subarrays, and each subarray is composed of a plurality of power dividers and a plurality of radiation elements.

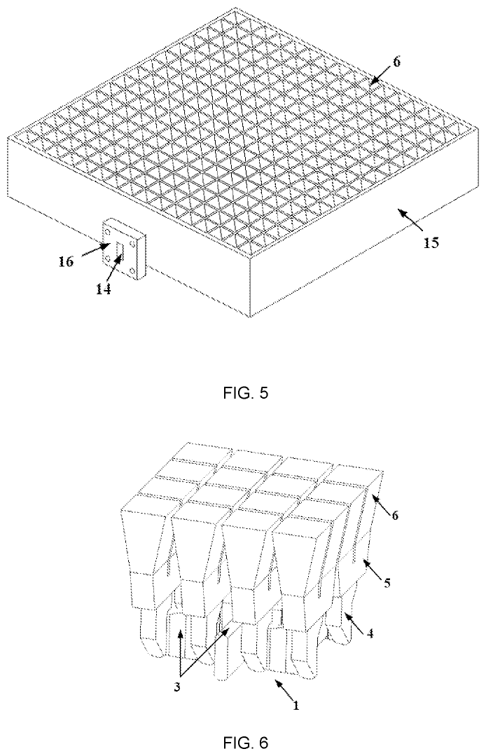

In the following, taking a 16×16 large-scale broadband planar array antenna as an example, referring to a structural diagram of a large-scale broadband planar array antenna shown in FIG. 5, the array antenna is nested inside a metal body 15 and connected with a radio frequency link by a flange 16. Electromagnetic energy enters the feed network through a standard waveguide inlet 14, and is equally divided into sixteen paths, the energy in each path is then equally divided into eight paths by a sub-feed network, the electromagnetic energy in each path is then fed into an H-plane power divider, and equally divided into two paths by the H-plane power divider, and the electromagnetic energy is finally fed into a radiation element 6, and radiates towards a free space to complete an energy conversion process.

Based on the above method process, an operating band and a center frequency of the above array antenna may be designed according to engineering requirements, and a form, a dimension and an element spacing of the radiation elements and a size of the array antenna may be selected.

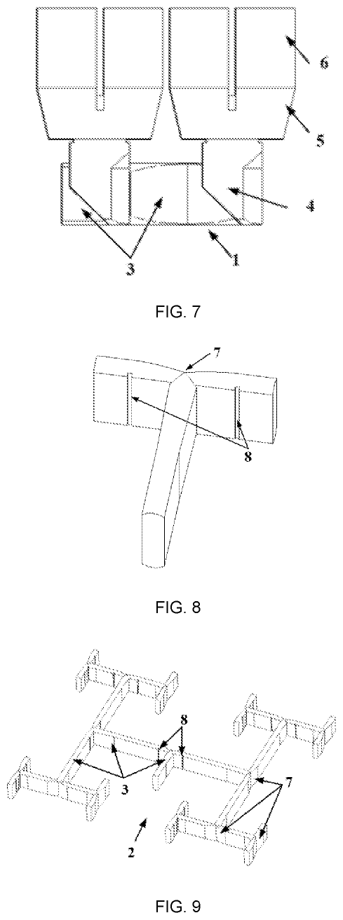

Specifically, FIG. 6 shows a schematic diagram of a three-dimensional structure of a 4×4 subarray, and FIG. 7 shows a side view of a 4×4 subarray.

The 4×4 subarray 1 is composed of a sub-feed network 4 composed of three power dividers 3, H-plane power dividers 5 and radiation elements 6, and each of the three parts of the subarray 1 has broadband characteristics.

In order to implement a broadband planar array antenna, the 4×4 subarray 1 and feed network 2 with broadband characteristics are designed, the subarray 1 is connected to an output port of the feed network 2 as a load, and it should be noted that the load may be in various forms, and besides the above forms, the load may be a single radiation unit, or has various sizes, such as a 1×2 subarray, a 2×2 subarray, a 2×4 subarray, or the like. The form of the radiation element is not limited to a horn antenna element in the present disclosure, and may also be a patch antenna element, a magneto-electric dipole antenna element, or the like, and the form of the load and the form of the radiation element are not particularly limited herein.

Specifically, FIG. 8 shows a schematic structural diagram of a power divider, a triangular iris 7 on the power divider and a rectangular iris 8 on an output branch are used for matching adjustment, and in the embodiment of the present application, a triangular iris is taken as an example, but in practical applications, for selection of the iris, various forms, such as a triangular iris, a rectangular iris, an arc iris, a trapezoidal iris, or the like, may be adopted to achieve an matching adjustment effect, and therefore, the form of the iris is not particularly limited.

A gradually changed structure of an input branch of the power divider 3 as well as the triangular iris 7 and the rectangular iris 8 on the output branch are used for matching adjustment to achieve a wideband performance, the feed network 2 is composed of 4 power dividers 3, FIG. 9 shows a schematic structural diagram of a feed network, and an array formed by the subarray 1 and the feed network 2 has a size of 16×16.

After the size of the array antenna is determined, and the broadband subarray and the feed network are arrayed according to the size of the array antenna, the reflection coefficient of the array antenna may be calculated according to the one-time-reflection model formula in the above-mentioned method, the bandwidth of the array is optimized according to the method, the optimization variable is the added value of the path length of the feed network. The optimization target is the maximum bandwidth with the reflection coefficient lower than the set amplitude value, and the path length of the feed network is adjusted.

Specifically, the path length of the feed network of the array may be adjusted according to the added value of the path length obtained by the optimization algorithm. FIG. 10 shows a schematic diagram of a bending structure for increasing the path length of the feed network. The bending structure 9 is composed of a plurality of bending joints 11, and each bending joint has a bending angle of 90 degrees. It should be noted that the structure for increasing the path length may be designed in various forms, including the above-mentioned right-angled structure, or a non-right-angled structure, an S-shaped structure, a trapezoidal structure, a triangular structure, a W-shaped structure, and a zigzag structure; that is, any structure capable of realizing path length adjustment may achieve the purpose of the present disclosure, and the specific form of the structure is not specifically limited herein. In the drawing, the right-angled form is taken as an example, and when the bending structure 9 is designed, a phase compensation amount is controlled mainly by adjusting a downward bending length h of the bending structure, and a distance I between the bending joints and a width w of a bending branch and a triangular iris and rectangular iris structure 10 are adjusted to realize matching. In a practical application process, the above-mentioned iris may be in various forms, such as a triangular iris, a rectangular iris, an arc iris, a trapezoidal iris, or the like, so as to achieve the matching adjustment effect, and therefore, the specific form of the iris is not limited particularly. A path length increased by the bending structure is guaranteed to be consistent with a path length obtained using the particle swarm algorithm by phase comparison, and finally, the bending structure is provided on the output branch of the power divider.

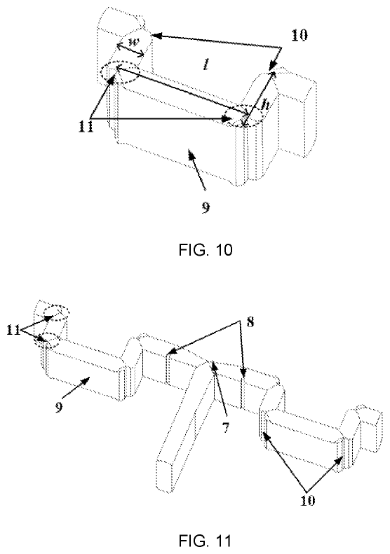

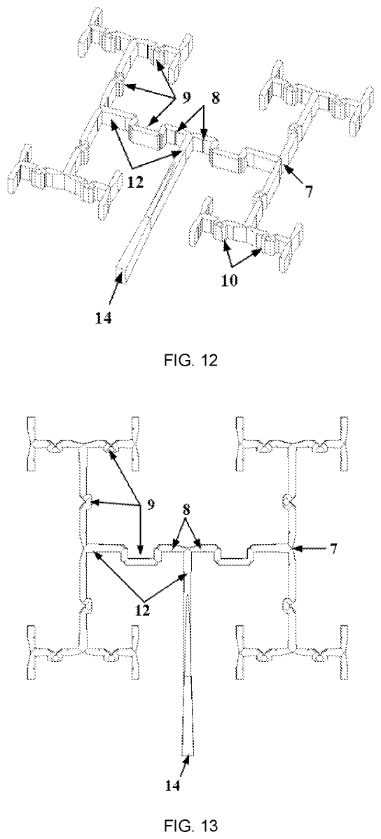

Specifically, FIG. 11 shows a schematic structural diagram of a power divider with an increased path length. FIG. 12 shows a schematic diagram of a three-dimensional structure of a feed network with an increased path length, FIG. 13 shows a top view of a feed network with an increased path length. After the path length is adjusted, the power divider may be set as the power divider 12 with the increased path length.

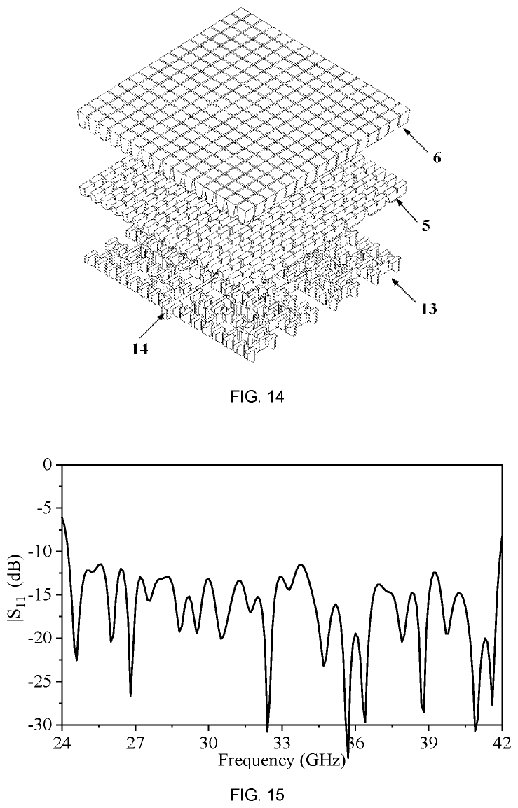

FIG. 14 shows a schematic diagram of a three-layer structure of an array with an increased path length, wherein electromagnetic energy enters a feed network 13 with an increased path length through a standard waveguide inlet 14, and is equally divided into sixteen paths, the energy in each path is then equally divided into eight paths by a sub-feed network 4, the energy in each path is then fed into an H-plane power divider 5, and equally divided into two paths by the H-plane power divider 5, and the electromagnetic energy is finally coupled to a radiation element 6, and radiates towards a free space to complete an energy conversion process. Finally, using the large-scale array antenna bandwidth enhancement method based on phase regulation and control, the designed 16×16 large-scale planar array antenna achieves a −11 dB bandwidth of more than 50%, and FIG. 15 shows a graph of a reflection coefficient of the 16×16 large-scale array antenna with an enhanced bandwidth.

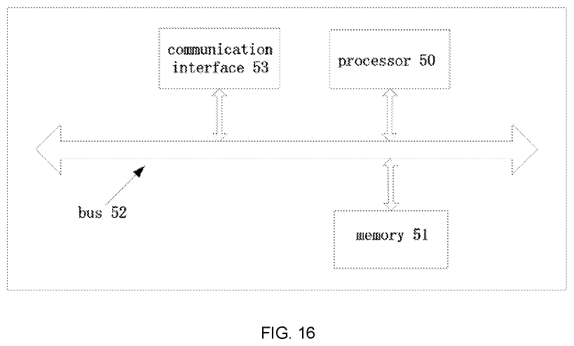

An embodiment of the present disclosure further provides an electronic device, as shown in FIG. 16 which is a schematic structural diagram of the electronic device, including a processor 50 and a memory 51, wherein the memory 51 stores machine executable instructions executable by the processor 50, and the processor 50 executes the machine executable instructions to implement the above-mentioned array antenna bandwidth enhancement method.

In the embodiment shown in FIG. 16, the electronic device further includes a bus 52 and a communication interface 53, and the processor 50, the communication interface 53, and the memory 51 are connected by the bus.

The memory 51 may include a high-speed random access memory (RAM) or a non-volatile memory, such as at least one disk memory. Communication connection between a system network element and at least one other network element is implemented through the at least one communication interface 53 (which may be wired or wireless), and the Internet, a wide area network, a local area network, a metropolitan area network, or the like, may be used. The bus may be an ISA bus, PCI bus, EISA bus, or the like. The bus may be divided into an address bus, a data bus, a control bus, or the like. For ease of representation, the bus is represented by only one double-headed arrow in FIG. 16, but this does not mean that only one bus or one type of buses exist.

The processor 50 may be an integrated circuit chip having a signal processing capability. In an implementation process, the steps of the above method may be completed by hardware integrated logic circuits or instructions in the form of software in the processor 50. The processor 50 may be a general-purpose processor, including a central processing unit (CPU), a network processor (NP), or the like; or a digital signal processor (DSP), an application specific integrated circuit (ASIC), a field-programmable gate array (FPGA) or other programmable logic devices, discrete gate or transistor logic devices, or discrete hardware components, such that various methods, steps, and logic blocks in the embodiments of the present disclosure may be implemented or executed. The general-purpose processor may be a microprocessor, any conventional processor, or the like. The steps of the method according to the embodiments of the present disclosure may be directly implemented by a hardware decoding processor, or implemented by a combination of hardware and software modules in a decoding processor. The software module may be located in a storage medium well known in the art, such as a random access memory, a flash memory, a read-only memory, a programmable read-only memory, an electrically erasable programmable memory, a register, or the like. The storage medium is located in the memory, and the processor 50 reads information in the memory 51, and completes the steps of the array antenna bandwidth extension method according to the foregoing embodiment in combination with hardware thereof.

An embodiment of the present disclosure further provides a machine-readable storage medium storing machine executable instructions which, when invoked and executed by a processor, cause the processor to implement the above-mentioned array antenna bandwidth enhancement method, and for specific implementation, reference may be made to the method embodiment, and details are not repeated herein.

The array antenna bandwidth enhancement method, the apparatus and a computer program product of the electronic device according to the embodiments of the present disclosure include a computer-readable storage medium storing a program code, wherein instructions included in the program code may be used to execute the array antenna bandwidth extension method according to the foregoing method embodiment, and for specific implementation, reference may be made to the method embodiment, and details are not repeated herein.

When the functional unit is implemented in the form of a software functional unit and sold or used as an independent product, the functional unit may be stored in a non-volatile computer-readable storage medium executable by a processor. Based on such an understanding, the technical solutions of the present disclosure essentially, or the part contributing to the prior art, or a part of the technical solutions may be implemented in the form of a software product. The computer software product is stored in a storage medium and includes several instructions for instructing a computer device (which may be a personal computer, a server, or a network device) to perform all or a part of steps of the method described in the embodiment of the present disclosure. Moreover, the above-mentioned storage medium includes various media capable of storing program codes, such as a USB flash disk, a mobile hard disk, a read-only memory (ROM), a random access memory (RAM), a magnetic disk, an optical disk, or the like.

In addition, in the description of the embodiments of the present disclosure, unless specified or limited otherwise, the terms “mounted”, “connected”, and “coupled” and the like are used broadly, and may be, for example, fixed connections, detachable connections, or integral connections; may also be mechanical or electrical connections; may also be direct connections or indirect connections via intervening structures; may also be inner communications of two elements. The above terms can be understood by those skilled in the art according to specific situations.

In descriptions of the present disclosure, it should be noted that, directions or positional relationships indicated by terms “center”, “upper”, “lower”, “left”, “right”, “vertical”, “horizontal”, “inner”, “outer”, etc. are based on orientations or positional relationships shown in the accompanying drawings, and they are used only for describing the present disclosure and for description simplicity, but do not indicate or imply that an indicated apparatus or element must have a specific orientation or be constructed and operated in a specific orientation. Therefore, it cannot be understood as a limitation on the present disclosure. In addition, the terms such as “first”, “second” and “third” are only used for purposes of description and are not intended to indicate or imply relative importance.

Finally, it should be noted that the above embodiments are only specific implementations of the present disclosure and used to illustrate the technical solutions of the present disclosure, but not to limit them, and the protection scope of the present disclosure is not limited thereto; although the present disclosure is described in detail with reference to the above embodiments, those having ordinary skill in the art should understand that any person skilled in the art still can modify technical solutions recited in the aforesaid embodiments or easily envisage changes or equivalently replace partial technical features therein within the technical scope of the present disclosure; these modifications, changes or substitutions do not make essence of corresponding technical solutions depart from the spirit and scope of the technical solutions of the embodiments of the present disclosure, and are intended to be covered by the protection scope of the present disclosure. Therefore, the protection scope of the present disclosure shall be subject to the protection scope of the claims.

What is claimed is:

1. An array antenna bandwidth enhancement method based on phase regulation and control, comprising:
determining a size of an array antenna based on engineering requirements, and forming a broadband subarray and a feed network according to the size of the array antenna, wherein the feed network is formed by connecting a plurality of stages of power dividers in parallel;
determining a one-time-reflection model formula based on a small reflection theory, wherein the one-time-reflection model formula is used for representing a corresponding relationship among a reflection coefficient and the size of the array antenna, a reflection coefficient of the power dividers and a path length of the feed network;
adjusting added values of the path length of the feed network in conjunction with an optimization algorithm, further adjusting a phase compensation value, determining the reflection coefficient corresponding to the array antenna using the one-time-reflection model formula, and obtaining a maximum bandwidth with the reflection coefficient lower than a preset value and a corresponding added value of the length of the path; and
employing the bending structures to change lengths of a plurality of paths in the feed network according to the added values of the path length, and re-arraying the bending structures to enhance a bandwidth of the array antenna.

2. The array antenna bandwidth enhance method according to claim 1, wherein the one-time-reflection model formula is represented as follows:
$$Γ = {Γ}_{1} + {\sum }_{i = 2}^{M + N} ( {Γ}_{i} \cdot {e}^{- 2 j {θ}_{i - 1}} \cdot {\prod }_{2}^{i} {Tr}_{i - 1} ) + {Γ}_{L} \cdot {e}^{- 2 j {θ}_{M + N}} {\prod }_{1}^{M + N} {Tr}_{i} ;$$
wherein Γ is the reflection coefficient, Γᵢ is the reflection coefficient of the power divider Tᵢ, Trᵢ=1+Γᵢ, Trᵢ is a transmission coefficient of the power divider Tᵢ (i=1, 2, 3, . . . , M+N), Γ_{L} is a reflection coefficient of the subarray (load) in the array antenna, θᵢ₋₁=βLᵢ₋₁ (i=2, 3, . . . , M+N), θ is a phase delay, β is a phase constant, Lᵢ₋₁=lᵢ₋₁+Δlᵢ₋₁+Lᵢ₋₂ (i=2, 3, . . . , M+N), Lᵢ₋₁ is a path length from the input port of the feed network to the power divider Tᵢ and L_{M+N} is the path length from the input port of the array to the load, lᵢ₋₁ is a path length between power dividers Tᵢ₋₁ and Tᵢ, l_{M+N} is the path length between power divider T_{M+N} and the loads. Δlᵢ₋₁, is an added value of the path length between the power divider Tᵢ₋₁ and Tᵢ, Δl_{M+N} is an added path length between power divider T_{M+N} and the loads, and M+N is a number of the power dividers in the feed network. L₀ is set to 0.

3. The array antenna bandwidth enhancement method according to claim 1, wherein adjusting the added values of lengths of plural paths of the feed network in conjunction with an optimization algorithm, further adjusting the phase compensation value, determining the reflection coefficient corresponding to the array antenna using the one-time-reflection model formula, and obtaining the maximum bandwidth with the reflection coefficient lower than a preset value and a corresponding added value of the length of the path comprises:
adjusting the added values of the lengths of the plural paths in the feed network, and further adjusting the phase compensation value, so as to adjust phase delays generated by a plurality of small reflections in a corresponding feed network at different operating frequencies, the added values of the lengths of the plural paths in the feed network corresponding to optimization variables in the optimization algorithm;
substituting a phase of the small reflection into the one-time-reflection model formula to obtain an amplitude value of a corresponding reflection coefficient;
evaluating fitness of the added values of the lengths of the paths based on the amplitude value, wherein a fitness function is a maximum bandwidth with an amplitude value of the reflection coefficient of the array antenna lower than a preset amplitude value, and performing plural iterations to obtain an optimal solution; and
obtaining the maximum bandwidth with the reflection coefficient lower than the preset amplitude value and the corresponding added value of the length of the path.

4. The array antenna bandwidth enhancement method according to claim 3, further comprising:
evaluating the fitness of the added values of the lengths of the paths based on a following formula:
BW′=max((fₘₐₓ−fₘᵢₙ)/f₀)
wherein BW′ is the fitness, fₘₐₓ is a frequency corresponding to an upper limit of the amplitude value, fₘᵢₙ is a frequency corresponding to a lower limit of the amplitude value, and f₀=(fₘₐₓ+fₘᵢₙ)/2, which is a center frequency.

5. The array antenna bandwidth enhancement method according to claim 3, wherein the optimization algorithm comprises one of a particle swarm optimization algorithm, a genetic algorithm, a simulated annealing algorithm or a neural network algorithm.

6. An array antenna bandwidth enhancement design apparatus, comprising:
a first determining module, configured to determine a size of an array antenna based on engineering requirements, and array a broadband subarray and a feed network according to the size of the array antenna, wherein the feed network is formed by connecting a plurality of stages of power dividers in parallel;
a second determining module, configured to determine a one-time-reflection model formula based on a small reflection theory, wherein the one-time-reflection model formula is used for representing a corresponding relationship among a reflection coefficient and the size of the array antenna, a reflection coefficient of the power dividers and a path length of the feed network;
a third determining module, configured to adjust added values of the path length of the feed network in conjunction with an optimization algorithm, further adjust a phase compensation value, determine the reflection coefficient corresponding to the array antenna using the one-time-reflection model formula, and obtain a maximum bandwidth with the reflection coefficient lower than a preset value and the corresponding added value of the path length; and
an arraying module, configured to employ the bending structures to change lengths of a plurality of paths in the feed network according to the added values of the path length, and re-form the bending structures to enhance a bandwidth of the array antenna.

7. A wideband air-filled waveguide array antenna, wherein the array antenna is obtained using the method according to claim 1 and comprises:
a feed network and a subarray, wherein the feed network is formed by connecting a plurality of stages of power dividers in parallel; and the subarray is connected at an output port of the feed network as a terminal load.

8. The array antenna according to claim 7, wherein the array antenna further comprises a plurality of subarrays, and each subarray is composed of a plurality of power dividers and a plurality of radiation elements.

9. The array antenna bandwidth enhancement method based on phase regulation and control according to claim 1, wherein since a change in a dimension of wide side of waveguide can effectively adjust the phase constant β in a phase delay calculation formula qᵢ₋₁=βLᵢ₋₁, a method for implementing phase regulation and control further comprises changing the dimension of wide side of the feed waveguide.
